(19) United States
(12) Patent Application Publication
(10) Pub. No.: US 2004/0192114 A1
(43) Pub. Date: Sep. 30, 2004

(54) Multi-signal transferred connector

(76) Inventor: Han-Sen Liou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/397,300

(22) Filed: Mar. 27, 2003

(51) Int. Cl. H01R 24/00

(52) U.S. Cl. 439/630

(57) ABSTRACT

The present invention relates to a multi-signal transferred connector, which includes a receiver mounted on an IC board having provided with several sets of pins. The receiver has a channel with a side stepped opening, which is capable of engaging with different memory cards having various sizes firmly, such as MS card, SM card, and MM card. The IC board has provided with an expanding joint having expanding groove on the other side, which is used for engaging with another memory card whenever is needed.

### FIELD OF THE INVENTION

The present invention relates to a connector having multi-function for transferring different input signals.

### BACKGROUND OF THE INVENTION

Due to quick progress in electronic technique, there are many different memory cards being designed for various machines. Each memory card always has different size. In order to read the data saved in the memory card and to send the data to a computer for editing, a relative connector must be provided. At this time, there are many different kinds of memory card and connector. It is not convenient for any user. It is known that the prior memory card includes Smart Media Card (SM card), Memory Stick Card (MS card), Multi Media Card (MM card), and Secure Digital Card (SD card). Each memory has different structure, such as size, and position of connecting pin. A known improvement has been designed, which includes a box connecting with an upper IC board and a bottom IC board, which provides three channels for receiving relatively three memory cards. This structure can just solve the problem at this moment. However, when a fourth or fifth memory card, it can not be used certainly. Moreover, the known structure includes a box and two IC boards, wherein the engagement therebetween is not strong enough. If a bias or looseness happens, the connection will be fail.

### BRIEF DESCRIPTION OF ACCOMPANYING DRAWINGS

Now the features and advantages of the present invention will be described in detail with reference to the accompanying drawings.

FIG. 1 is a perspective view showing a multi-signal transferred connector according to the present invention.

FIG. 2 is an exploded perspective view of FIG. 1.

FIG. 3 is a perspective view showing the connector in up side down position of FIG. 2 according to the present invention.

FIG. 4 is a perspective view showing the connector of FIG. 3 to connect with a SM card.

FIG. 5 is a perspective view showing the connector of FIG. 3 to connect with an MS card.

FIG. 6 is a perspective view showing the connector of FIG. 3 to connect with a MM card or a SD card.

### DETAILED DESCRIPTION OF PREFERRED EMBODIMENTS

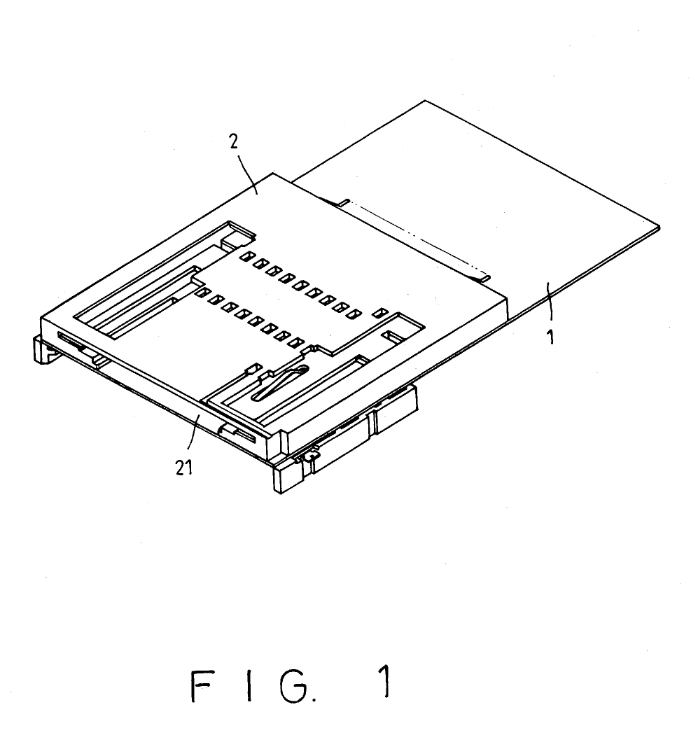

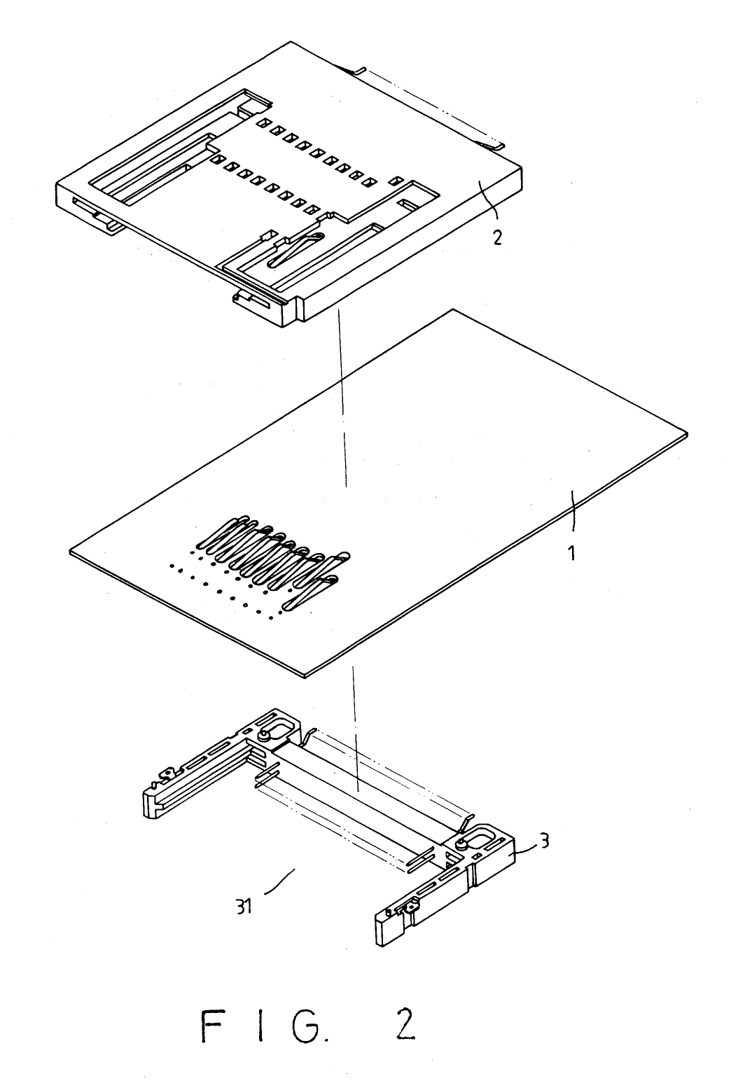

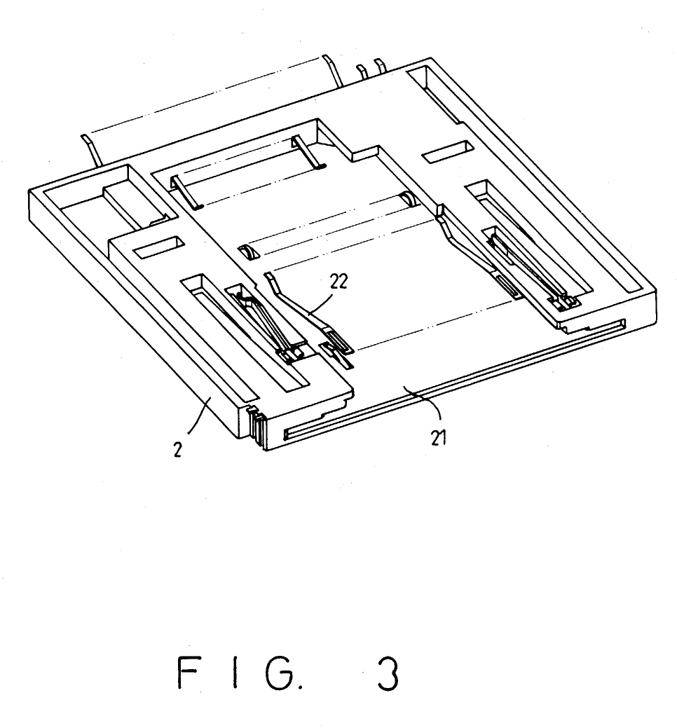

As shown in FIGS. 1 and 2, the present invention relates to a connector, which has multi-function for transferring different input signals in various memory cards. The connector includes an IC board (1) and a receiver (2), wherein the IC board (1) has provided with several sets of connecting pins (11) thereon and the receiver (2) has provided with a side channel (21). The channel (21) has a stepped opening, which can be suitable for engaging with different memory cards being various sizes in match. The engagement will be secure with no doubt. Moreover, the receiver (2) has provided with the relative pin (22) inside the channel (21), as shown in FIG. 3.

The IC board (1) has provided the other side with an expanding joint (3) having an expanding groove (31). This expanding joint (3) can be chosen whenever an actually necessity is happened.

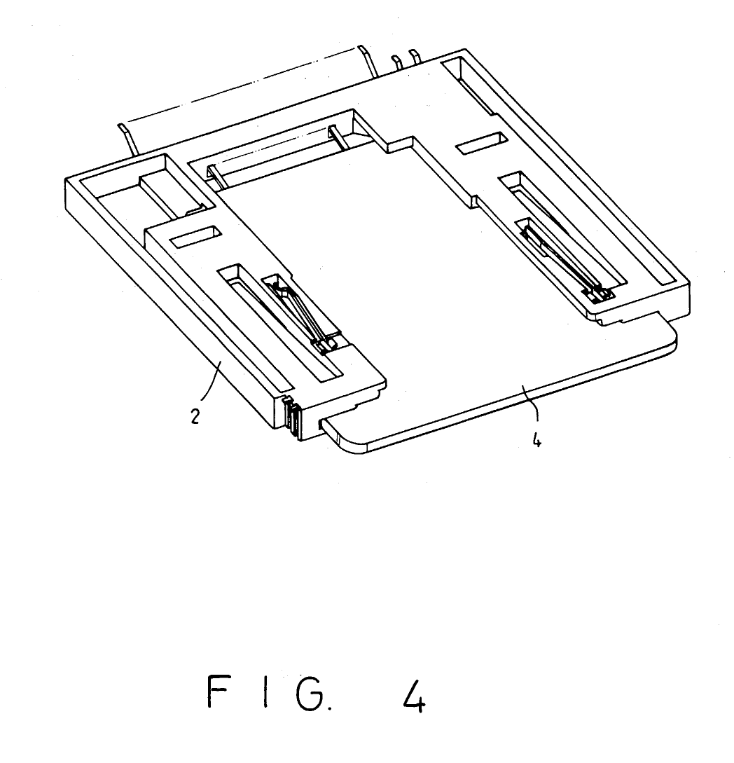

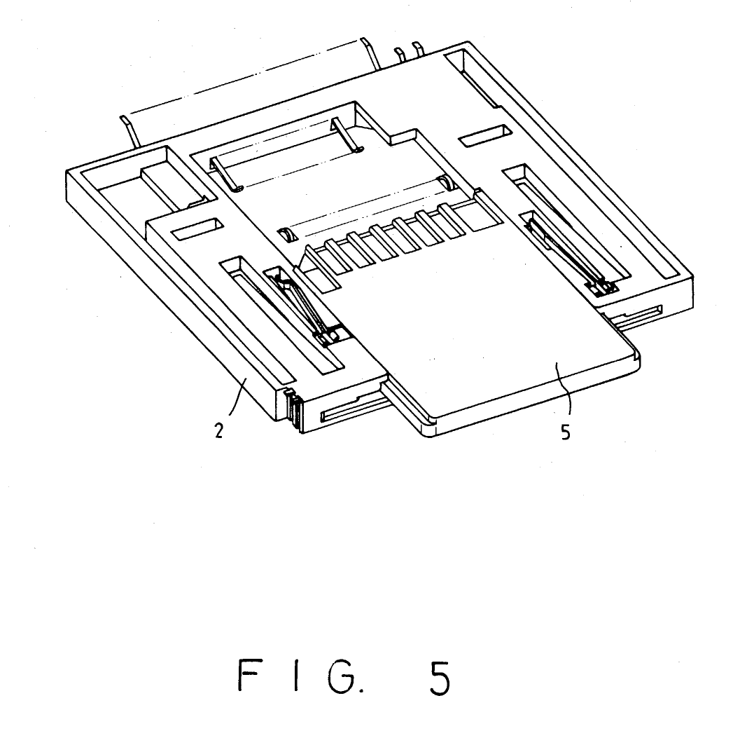

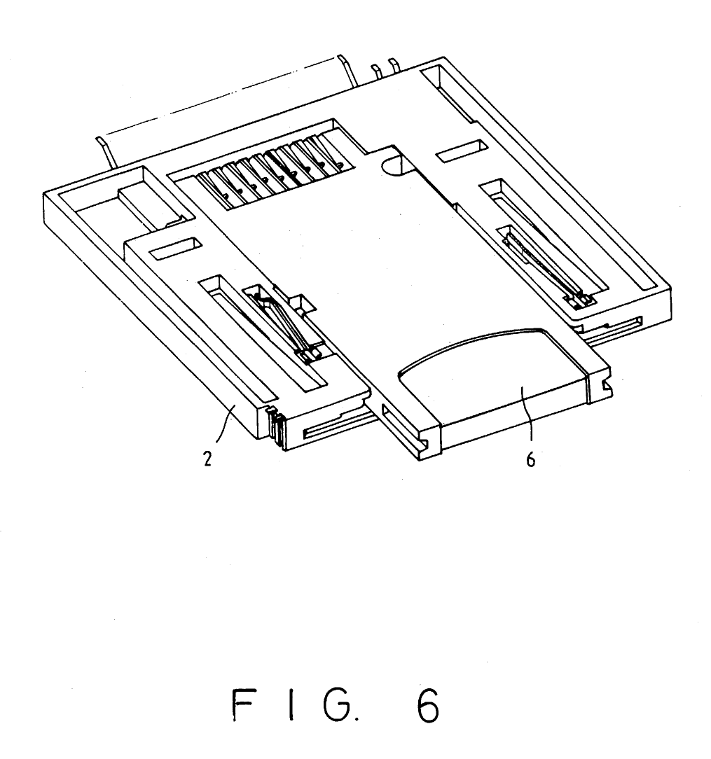

In practice, the connector of the present invention uses the receiver (2) mounted on the IC board (1), while the channel (21) of the receiver (2) is capable of assembling the SM card (4) in FIG. 4, the MS card (5) in FIG. 5, or MM/SD card in FIG. 6. It obtains a firm engagement therebetween. And by use of the connection between the connecting pin (22) inside the channel and the pin on each memory card, it can read the data in the memory card and transfers the data to computer or any other processor.

Another improvement of the present invention is to provide an expanding joint on the other side of the IC board possibly. For example in FIG. 1 and 2, the expanding groove (31) of the joint (3) can relatively engage with a Compact Flash Card (CF card) or whatever else. It will be understood that the present invention provides a selected program for future use and it is the best improvement.

1-2 (Cancelled).

3 A multi-signal transfer connector for interfacing with a plurality of different types of memory cards, comprising:
an IC board having a plurality of sets of pins extending therefrom;
a receiver mounted to a first side of said IC board, said receiver having a longitudinally extended channel formed therein, said channel having a stepped opening formed at one longitudinal end thereof for securely engaging any memory card selected from the group consisting of a smart media card, a memory stick, a multi media card, and a secure digital card; and,
an expanding joint coupled to an opposing second side of said IC board, said expanding joint having an expanding groove formed therein for engaging a compact flash memory card.
